(19) United States
(12) Patent Application Publication
(10) Pub. No.: US 2010/0295825 A1
(43) Pub. Date: Nov. 25, 2010

(54) POINTING INPUT DEVICE HAVING SHEET-LIKE LIGHT BEAM LAYER

(75) Inventor: LI-WEN TING, Miaoli County (TW)

Correspondence Address: WPAT, PC;Suite 200, 1940 Duke St., Alexandria, VA, 22314, US

(73) Assignee: Micro-Nits Co., Ltd., Miaoli County (TW)

(21) Appl. No.: 12/785,689

(22) Filed: May 24, 2010

(30) Foreign Application Priority Data
May 25, 2009 (TW) 098117270

(51) Int. Cl. G06F 3/042

(52) U.S. Cl. 345/175

(57) ABSTRACT

A pointing input device includes a sheet-like light beam layer and a detector. The sheet-like light beam layer abuts a display screen and is distributed on a surface of a display screen, and includes plural light beams. The sheet-like light beam layer is generated by at least one light-generating module having a dot light source. The detector is for detecting a light spot composed of plural reflective beam when a physical object is intervened into the sheet-like light beam layer, so that a pointing input operation is performed on a specified position of the display screen corresponding to the light spot. Once the physical object is intervened into the sheet-like light beam layer, the light beams are sheltered by the physical object, so that the light spot with a reflective bright border is resulted from a touching action of the physical object.

### FIELD OF THE INVENTION

The present invention relates to a pointing input device, and more particularly to a pointing input device having a flat or curved light beam layer.

### BACKGROUND OF THE INVENTION

With rapid development of the pointing input technology, it is important to provide a pointing input device with a more simplified, responsible and interactive input operating interface.

FIGS. 1A, 1B and 1C are schematic diagrams illustrating three types of pointing input devices according to the prior art.

As shown in FIG. 1A, the conventional pointing input device 10 comprises a display screen 12 (e.g. a projection screen), a rear projection type projector 13 and a detector 14 (e.g. an image capture device or an optical receiver). The projector 13 has a projecting beam range between the boundary lines I11, and the detector 14 has a detecting beam range between the boundary lines I12.

When a user 11 uses a laser pointer or a pointing stick (not shown) to transmit an indication point to a specified position X1 of the projection screen 12 via a transmitting action M (e.g. a projecting action or a directing action), the indication point is detected by the detector 14. Then, image signal comparison and image analysis are performed by a host (not shown), which is electrically connected to the projector 13 and the detector 14. As such, the coordinate value corresponding to the specified position X1 is realized. After the coordinate value is realized, the host will perform a pointing input operation on the specified position X1 of the projection screen 12.

FIG. 1B schematically illustrates another type of conventional pointing input device. As shown in FIG. 1B, the conventional pointing input device 20 comprises a display screen 21 and two detectors 22 and 23, which are respectively arranged on left and right corners of the screen 21. These two detectors 22 and 23 may be video cameras. For example, the display screen 21 is a screen of the common electronic appliance such as a television, a LCD television, a plasma television, a handwriting board, a handheld device, or the like.

A common operating method of the pointing input device 20 will be illustrated with reference to FIG. 1B. When a user places an actively-illuminating light pen (not shown) on a specified position X2 of the display screen 21, a light spot is detected by the video cameras 22 and 23. Then, image signal comparison and image analysis are performed by a host (not shown), which is electrically connected to the display screen 21 and the two video cameras 22 and 23. As such, the coordinate value corresponding to the specified position X2 (i.e. the real position of the light spot) is realized. After the coordinate value is realized, the host will perform a pointing input operation on the specified position X2 of the display screen 21.

Another common operating method of the pointing input device 20 will be also illustrated with reference to FIG. 1B. As shown in FIG. 1B, two additional light-emitting bars 24 and 25 are disposed on both edges of the display screen 21. In addition, the detectors 22 and 23 are replaced by optical receivers in order to continuously receive the light beams 121 that are emitted from the light-emitting bars 24 and 25. When any physical object enters the coverage range of the light beams emitted from the light-emitting bars 24 and 25, some of the light beams are hindered and sheltered by the physical object and fail to be received by the optical receivers 22 and 23. After the physical object is detected by the optical receivers 22 and 23, image signal comparison and image analysis are performed by a host (not shown), which is electrically connected to the display screen 21 and the two optical receiver 22 and 23. As such, the coordinate value corresponding to the specified position X2 (i.e. the sheltered position) is realized. After the coordinate value is realized, the host will perform a pointing input operation on the specified position X2 of the display screen 21.

FIG. 1C schematically illustrates another type of conventional pointing input device. As shown in FIG. 1C, the conventional pointing input device 30 comprises a display screen 31, plural light-emitting elements 32 and plural light-receiving elements 33. The light-emitting elements 32 are arranged at the upper side and the left side of the display screen 31. The light-receiving elements 33 are arranged at the lower side and the right side of the display screen 31. The light-emitting elements 32 are aligned with respective light-receiving elements 33. As such, the light beams 131 emitted from the light-emitting elements 32 are continuously received by the corresponding light-receiving elements 33.

For example, the display screen 31 is a screen of the common electronic appliance such as a television, a LCD television, a plasma television, a handwriting board, a handheld device, or the like. When a physical object (e.g. a user's finger or a stick-like article) is placed on a specified position X3 of the display screen 31, some of the light beams emitted from the light-emitting elements 32 are sheltered by the physical object and fail to be received by some of the optical receivers33. As such, the coordinate value corresponding to the specified position X3 could be realized. After the coordinate value is realized, a pointing input operation is performed on the specified position X3 of the display screen 31 by the host, which is electrically connected to the display screen 31.

From the above discussions, according to the conventional technologies, the accurate pointing input position is determined by detecting the indication point from the actively-illuminating light pen or detecting the region sheltered by the physical object. The conventional methods, however, are not intuitively sensed or directly perceived. Especially when a touching action is performed, the user usually fails to sense the touching feel.

For obviating the drawbacks encountered from the conventional touch input technology, there is a need of providing an improved pointing input device.

### SUMMARY OF THE INVENTION

An object of the present invention provides a pointing input device having a sheet-like light beam layer. When a physical object is intervened into the light beam layer, a light spot with a reflective bright border is resulted from a touching action of a physical object, so that the touching action becomes conspicuous.

In accordance with an aspect of the present invention, there is provided a pointing input device. The pointing input device includes a sheet-like light beam layer and a detector. The sheet-like light beam layer abuts a display screen and is distributed on a surface of a display screen, and includes plural light beams. The sheet-like light beam layer is generated by at least one light-generating module having a dot light source. The detector is for detecting a light spot composed of plural reflective beam when a physical object is intervened into the light beam layer, so that a pointing input operation is performed on a specified position of the display screen corresponding to the light spot. Once the physical object is intervened into the sheet-like light beam layer, the light beams are sheltered by the physical object, so that the light spot with a reflective bright border is resulted from a touching action of the physical object.

In an embodiment, the light beam layer is a flat sheet-like light beam layer or a curved sheet-like light beam layer.

In an embodiment, the pointing input device includes a single light-generating module abutting a specified corner of the display screen.

In an embodiment, the pointing input device includes two light-generating modules respectively arranged on a left corner and a right corner of the display screen.

In an embodiment, the pointing input device includes two light-generating modules respectively arranged at one of an upper side and a lower side of the display screen and one of a left side and a right side of the display screen.

In an embodiment, the light-generating module includes a light-emitting element and an optical path adjusting mechanism. The light-emitting element abuts the surface of the display screen, and serves as the dot light source for generating a source light beam. The optical path adjusting mechanism is arranged corresponding to the light-emitting element for reflecting and/or refracting the source light beam, thereby generating the light beams of the sheet-like light beam layer.

In an embodiment, the optical path adjusting mechanism includes plural beam splitters arranged in parallel with each other, so that the source light beam is successively transmitted through and reflected by the beam splitters to generate the light beams.

In an embodiment, the optical path adjusting mechanism includes a polygonal reflective mirror, which is rotated to reflect the source light beam, thereby generating the light beams.

In an embodiment, the optical path adjusting mechanism includes a single-surface reflective mirror, which is rotated to reflect the source light beam, thereby generating the light beams.

In an embodiment, the optical path adjusting mechanism includes a meniscus concave-convex lens.

In an embodiment, the optical path adjusting mechanism further includes an angle-amplifying lens, which is arranged in front of the polygonal reflective mirror or in front of the single-surface reflective mirror for diverging the source light beam, thereby generating the light beams.

In an embodiment, the light beams are not interfered with each other, or interfered with each other in a staggered manner.

In an embodiment, the pointing input device further includes an additional optical path adjusting mechanism for guiding the light beams to an action region for detecting the physical object.

In an embodiment, the additional optical path adjusting mechanism includes plural flat reflective mirror or plural curved reflective mirrors.

In an embodiment, the detector includes a single video camera or a linear array arranged in front of or behind the display screen.

In an embodiment, the detector includes two video cameras or two linear arrays abutting the display screen and arranged on left and right corners of the display screen.

In an embodiment, the detector includes two video cameras or two linear arrays abutting the display screen and respectively arranged at one of an upper side and a lower side of the display screen and one of a left side and a right side of the display screen.

In an embodiment, the detector includes three or more than three video cameras or three or more than three linear arrays arranged in a line.

In an embodiment, the detector includes plural optical receivers distributed at the upper side, the lower side, the left side and/or the right side of the display screen.

In an embodiment, the physical object includes a finger, multiple fingers or a stick-like article.

In an embodiment, the display screen is a computer screen, a television screen, a handheld device screen, a handwriting board screen, a multi-screen video wall or a projection screen.

In an embodiment, when the pointing input operation is performed, pointing information associated with mouse left/right button, light spot position, light spot size and/or touching pressure is simultaneously identified and inputted.

In accordance with another aspect of the present invention, there is provided a pointing input device. The pointing input device includes at least one light-emitting element, an optical path adjusting mechanism and a detector. The at least one light-emitting element abuts a surface of the display screen, and serves as the dot light source for generating a source light beam. The optical path adjusting mechanism is arranged corresponding to the light-emitting element for reflecting and/or refracting the source light beam, thereby generating a sheet-like light beam layer having plural light beams. The detector is for detecting plural reflective beam when a physical object is intervened into the light beam layer and the light beams are sheltered by the physical object, so that an intervening position of the physical object is realized and a pointing input operation is performed on a specified position of the display screen corresponding to the intervening position of the physical object.

In an embodiment, the light beam layer is a flat light beam layer or a curved light beam layer.

In an embodiment, the at least one light-emitting element and the optical path adjusting mechanism collectively define a light-generating module.

The above objects and advantages of the present invention will become more readily apparent to those ordinarily skilled in the art after reviewing the following detailed description and accompanying drawings, in which:

### BRIEF DESCRIPTION OF THE DRAWINGS

FIGS. 1A, 1B and 1C are schematic diagrams illustrating three types of pointing input devices according to the prior art;

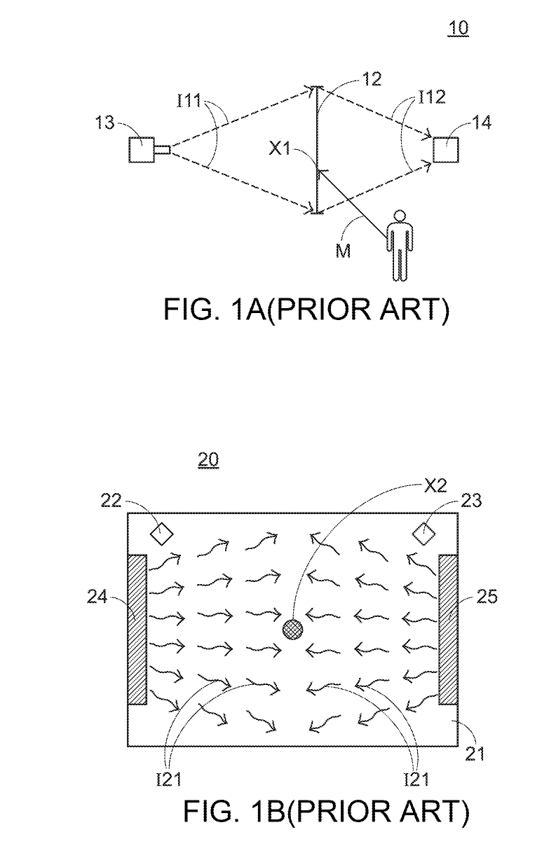

FIG. 2A is a schematic side view illustrating a pointing input device according to a first embodiment of the present invention before a touch input operation is performed;

FIG. 2B is a schematic side view illustrating the pointing input device according to the first embodiment of the present invention after the touch input operation is performed;

FIGS. 3A˜3F are schematic diagrams illustrating several examples of the light-generating module for generating the sheet-like light beam layer as shown in FIGS. 2A and 2B;

FIG. 4 is a schematic side view illustrating a pointing input device according to a second embodiment of the present invention before a touch input operation is performed;

FIG. 5 is a schematic top view illustrating a pointing input device according to a third embodiment of the present invention before a touch input operation is performed; and

FIG. 6 is a schematic top view illustrating a pointing input device according to a fourth embodiment of the present invention before a touch input operation is performed.

### DETAILED DESCRIPTION OF THE PREFERRED EMBODIMENT

It is to be noted that the following descriptions of preferred embodiments of this invention are presented herein for purpose of illustration and description only. It is not intended to be exhaustive or to be limited to the precise form disclosed.

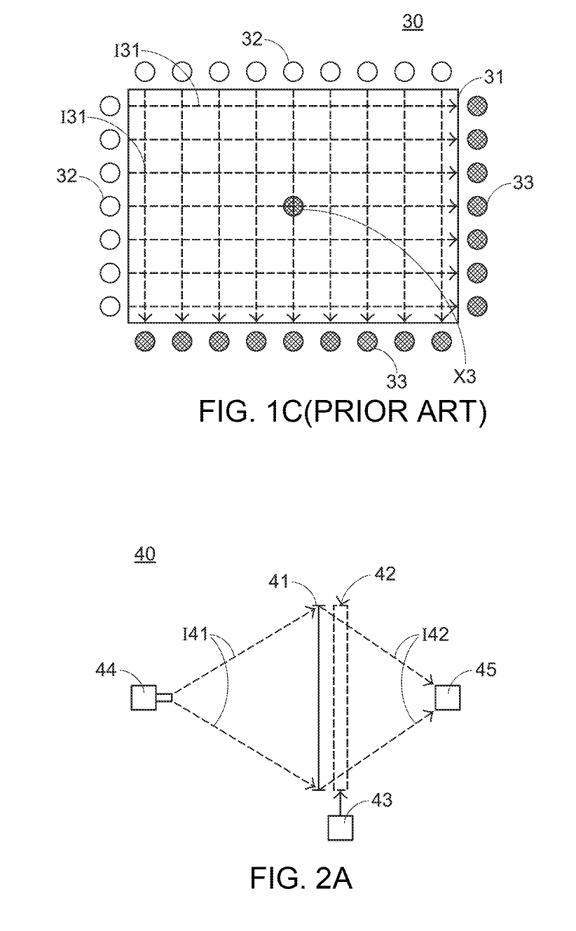

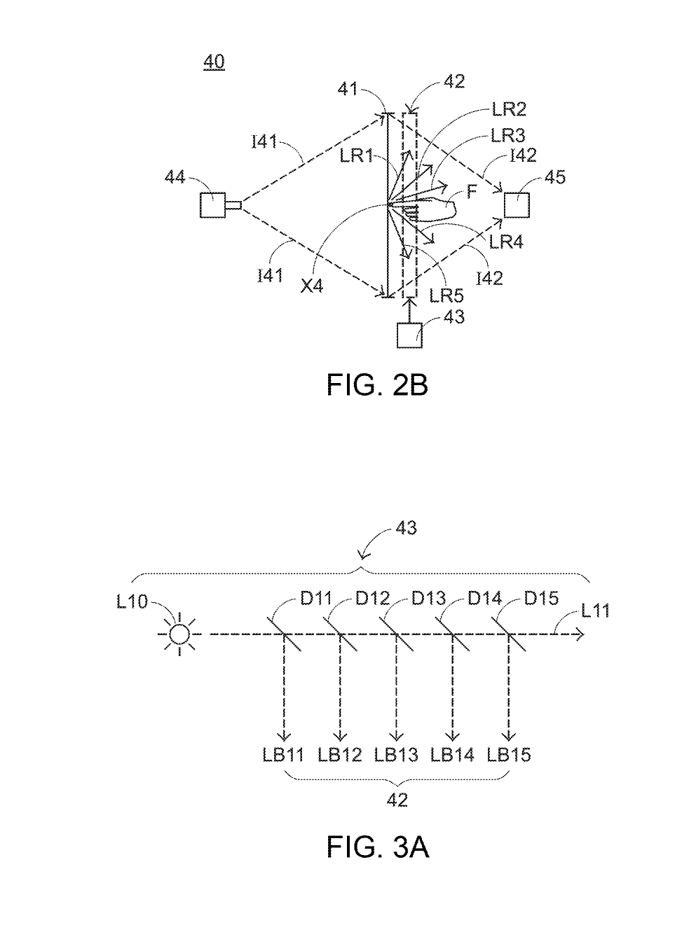

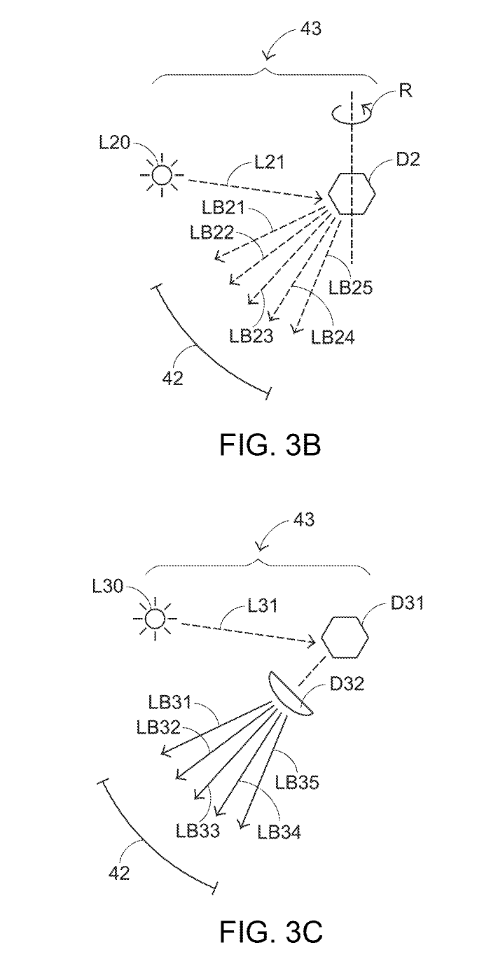

FIG. 2A is a schematic side view illustrating a pointing input device according to a first embodiment of the present invention before a touch input operation is performed. FIG. 2B is a schematic side view illustrating the pointing input device according to the first embodiment of the present invention after the touch input operation is performed. As shown in FIGS. 2A and 2B, the pointing input device 40 comprises a side-looking display screen 41, a flat or curved sheet-like light beam layer 42 including plural light beams, a light-generating module 43 for generating the sheet-like light beam layer 42, a projector 44 and a detector 45 (e.g. a video camera, a linear array or an optical receiver). The configurations and positions of the light-generating module 43 and the method of generating the light beams by the light-generating module 43 will be illustrated with reference to FIGS. 3A˜3F. In addition, the projector 44 has a projecting beam range between the boundary lines I41, and the detector 45 has a detecting beam range between the boundary lines I42.

The sheet-like light beam layer 42 abuts the display screen 41 and distributed on the surface of the display screen 41. The specified design should assure that, before a physical object F enters the sheet-like light beam layer 42 (see FIG. 2B), none of obvious reflective beams coming from the action region are received or captured by the detector 45. On the other hand, once the physical object F is intervened into the sheet-like light beam layer 42, the interference between the physical object F and the sheet-like light beam layer 42 results in a light spot, which is composed of several reflective beams LR1˜LR5. After a specified position X4 of the display screen 41 corresponding to the light spot is realized, a pointing input operation is performed on the specified position X4. In other words, once the physical object F is intervened into the sheet-like light beam layer 42, these light beams are sheltered by the physical object F, so that the light spot with a reflective bright border is resulted from the touching action of the physical object F.

Moreover, the physical object F includes for example a finger (see FIG. 2B), multiple fingers or a stick-like article (not shown). An example of the display screen includes but is not limited to a computer screen, a television screen, a handheld device screen, a handwriting board screen, a multi-screen video wall or a projection screen.

FIGS. 3A˜3F are schematic diagrams illustrating several examples of the light-generating module 43 for generating the sheet-like light beam layer 42. As shown in FIGS. 3A˜3D, the light-generating module 43 includes a single light-emitting element and an optical path adjusting mechanism, and the light-generating module is disposed beside the display screen 41. As shown in FIGS. 3E and 3F, the light-generating module 43 includes two light-emitting elements. Alternatively, the light-generating module 43 includes a single light-emitting element and an electrically-rotating driving device (not shown). It is noted that, however, those skilled in the art will readily observe that numerous modifications and alterations may be made while retaining the teachings of the invention.

Please refer to FIGS. 3A˜3E, 2A and 2B again. The light-generating module 43 comprises one or more light-emitting elements (L10, L20, L30, L40, L501˜L502) and an optical path adjusting mechanism (D11˜D15, D2, D31˜D32, D4, D5) corresponding to the light-emitting elements (L10, L20, L30, L40, L501˜L502). The light-emitting elements (L10, L20, L30, L40, L501˜L502) are arranged beside the surface of the display screen 41 and serve as dot light sources for generating one or more source light beams (L11 L21, L31, L41, L511˜L512), Due to reflection or refraction of the optical path adjusting mechanism (D11˜D15, D2, D31˜D32, D4, D5), the sheet-like light beam layer 42 with the light beams (LB11˜LB15, LB21˜LB25, LB31˜LB35, LB41˜LB45, LB51˜LB55) are generated. In this embodiment, the source light beams (L11 L21, L31, L41, L511˜L512) are visible light beams or invisible light beams. For example, the source light beams (L11 L21, L31, L41, L511˜L512) are laser beams or infrared beams.

The configurations of the light-generating module 43 for generating the light beams (LB11˜LB15, LB21˜LB25, LB31˜LB35, LB41˜LB45, LB51˜LB55) are somewhat distinguished from each other.

As shown in FIG. 3A, the optical path adjusting mechanism comprises plural beam splitters D11˜D15, which are arranged in parallel with each other. The source light beam L11 emitted from the light-emitting element L10 is successively transmitted through and reflected by the beam splitters D11˜D15, thereby generating the light beams LB11˜LB15.

As shown in FIG. 3B, the optical path adjusting mechanism comprises a polygonal reflective mirror D2. According to a rotating action R of the polygonal reflective mirror D2, the source light beam L21 emitted from the light-emitting element L20 is reflected by the polygonal reflective mirror D2, thereby generating the light beams LB21˜LB25.

As shown in FIG. 3C, the optical path adjusting mechanism comprises a polygonal reflective mirror D31 and an angle-amplifying lens D32. The angle-amplifying lens D32 is arranged in front of the polygonal reflective mirror D31. The source light beam L31 emitted from the light-emitting element L30 is reflected by the polygonal reflective mirror D31 and diverged by the angle-amplifying lens D32, thereby generating the light beams LB31˜LB35. Alternatively, the polygonal reflective mirror D31 may be replaced by a single-surface reflective mirror (not shown).

As shown in FIG. 3D, the optical path adjusting mechanism comprises a meniscus concave-convex lens D4. The source light beam L41 emitted from the light-emitting element L40 is diverged by the meniscus concave-convex lens D4, thereby generating the light beams LB41˜LB45.

As shown in FIG. 3E, the light-generating module 43 comprises two light-emitting elements L501˜L502. Similarly, the optical path adjusting mechanism comprises a meniscus concave-convex lens D5. The source light beams L511˜L512 emitted from the light-emitting element L501˜L502 are diverged by the meniscus concave-convex lens D5, thereby generating the light beams LB51˜LB55.

The light beams LB11˜LB15, LB21˜LB25, LB31˜LB35, LB41˜LB45, LB51˜LB55 are not interfered with each other. Alternatively, the light beams LB11˜LB15, LB21˜LB25, LB 31˜LB 35, LB41˜LB45, LB51˜LB55 may be interfered with each other in a staggered manner.

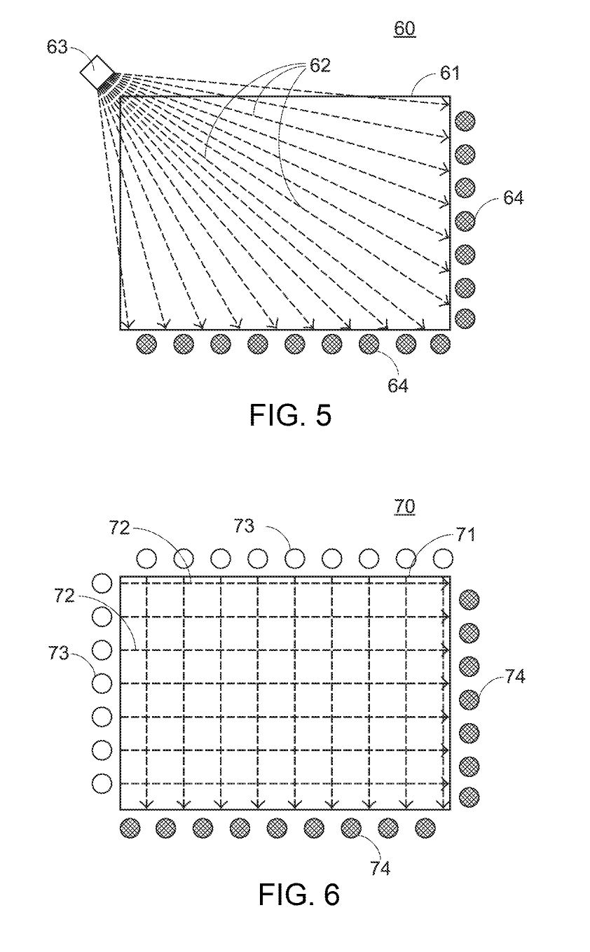

As shown in FIG. 3F, the optical path adjusting mechanism is omitted, but the light-generating module 43 comprises plural light-emitting elements L601˜L605. Moreover, the source light beams L611˜L615 emitted from the light-emitting element L601˜L605 may be directed at different emergence angles or parallel with each other (see FIG. 6).

Please refer to FIG. 2B. Once the physical object F (e.g. a single finger or multiple fingers) is intervened into the sheet-like light beam layer 42, these light beams (LB11˜LB15, LB21˜LB25, LB31˜LB35, LB41˜LB45, LB51˜LB55, L611˜L615) are sheltered by the physical object F, so that the light spot with a reflective bright border is resulted from the touching action of the physical object F. As a consequence, the touching action of a single finger or multiple fingers of the user becomes conspicuous. In addition, the light spot with a reflective bright border is helpful for identifying and inputting the pointing information (e.g. mouse left/right button, light spot position, light spot size and/or touching pressure), thereby providing better judgment.

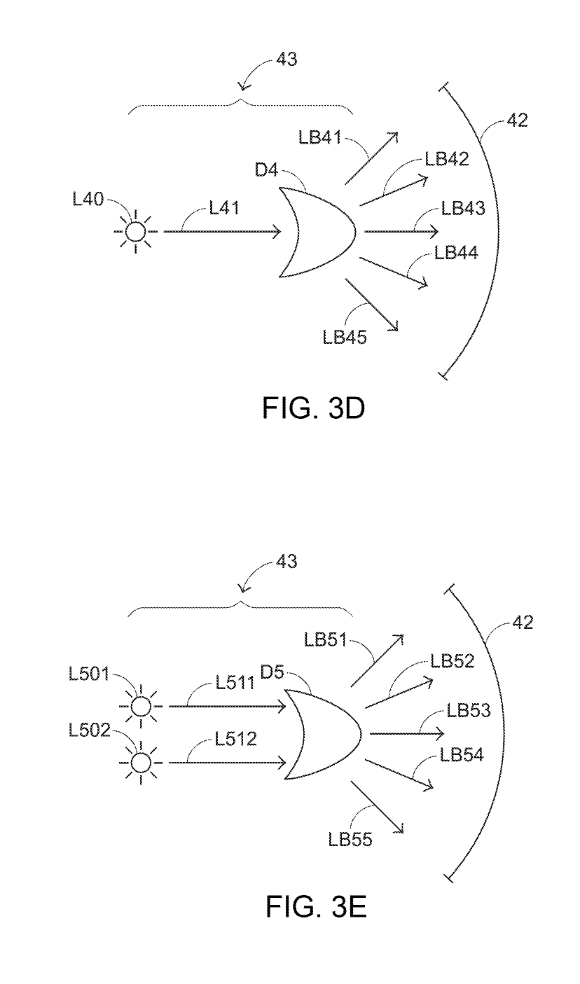

FIG. 4 is a schematic side view illustrating a pointing input device according to a second embodiment of the present invention before a touch input operation is performed. As shown in FIG. 4, the pointing input device 50 comprises a side-looking display screen 51, a sheet-like light beam layer 52 including plural light beams, a light-generating module 53 for generating the sheet-like light beam layer 52, and a detector 54 (e.g. a video camera, a linear array or an optical receiver). The detector 54 is arranged at the upper left side and/or the upper right side of the display screen 51. The configurations and positions of the light-generating module 53 and the method of generating the light beams by the light-generating module 53 are similar to the light-generating module 43 of FIGS. 2A˜2B, and are not redundantly described herein. In addition, the detector 54 has a detecting beam range between the boundary lines I51.

The sheet-like light beam layer 52 abuts the display screen 51 and distributed on the surface of the display screen 51. The specified design should assure that, before a physical object F enters the sheet-like light beam layer 52 (see FIG. 2B), none of obvious reflective beams are received or captured by the detector 54. On the other hand, once the physical object F is intervened into the sheet-like light beam layer 52, the interference between the physical object F and the sheet-like light beam layer 52 results in a light spot, which is composed of several reflective beams.

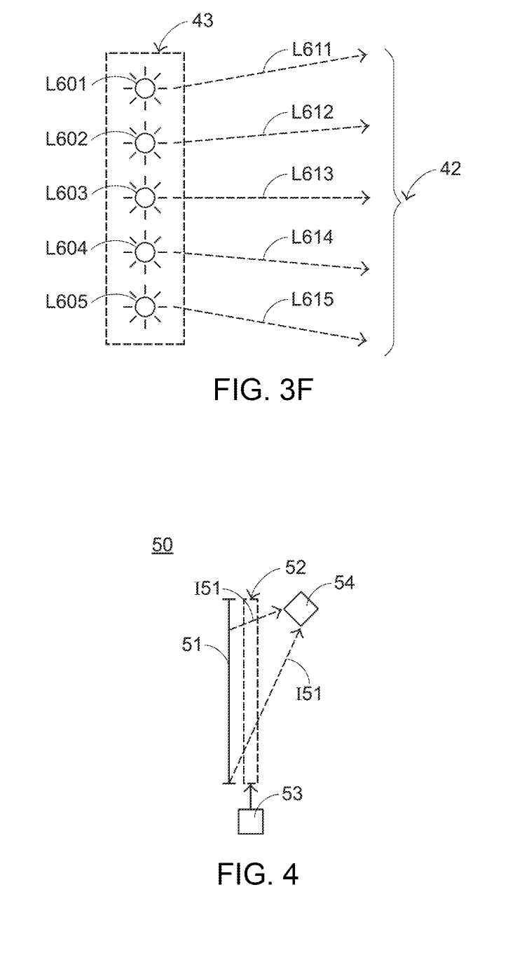

FIG. 5 is a schematic top view illustrating a pointing input device according to a third embodiment of the present invention before a touch input operation is performed. As shown in FIG. 5, the pointing input device 60 comprises a top-looking display screen 61, a sheet-like light beam layer 62 including plural light beams, a light-generating module 63 for generating the sheet-like light beam layer 62, and plural optical receivers 64. The optical receivers 64 are arranged at the lower side and the right side of the display screen 61. The optical receivers 64 are arranged such that the light beams emitted from the light-generating module 63 are not aligned with corresponding optical receivers 64. In addition, the specified design should assure that, before a physical object F enters the sheet-like light beam layer 62 (see FIG. 2B), none of obvious reflective beams are received or captured by the optical receivers 64. On the other hand, once the physical object F is intervened into the sheet-like light beam layer 62, the interference between the physical object F and the sheet-like light beam layer 62 results in a light spot, which is composed of several reflective beams. Moreover, a preferred embodiment of the light-generating module 63 is illustrated as shown in FIG. 3F.

FIG. 6 is a schematic top view illustrating a pointing input device according to a fourth embodiment of the present invention before a touch input operation is performed. As shown in FIG. 6, the pointing input device 70 comprises a top-looking display screen 71, a sheet-like light beam layer 72 including plural light beams, plural light-generating modules 73 for generating the sheet-like light beam layer 72, and plural light-receiving elements 74. The light-generating modules 73 are arranged at the upper side and the left side of the display screen 71. The light-receiving elements 74 are arranged at the lower side and the right side of the display screen 71.

The light-receiving elements 74 are arranged such that the light beams emitted from the light-generating modules 63 are not aligned with corresponding light-receiving elements 74. In addition, the specified design should assure that, before a physical object F enters the sheet-like light beam layer 72 (see FIG. 2B), none of obvious reflective beams are received or captured by the light-receiving elements 74. On the other hand, once the physical object F is intervened into the sheet-like light beam layer 72, the interference between the physical object F and the sheet-like light beam layer 72 results in a light spot, which is composed of several reflective beams.

A preferred embodiment of the light-generating modules 73 is shown in FIG. 3F. The light-generating module 43 comprises plural light-emitting elements L601˜L605 as the light source. Moreover, the source light beams L611˜L615 emitted from the light-emitting element L601˜L605 are parallel with each other.

In views of power-saving efficacy and cost-effectiveness, the pointing input device may comprise an additional optical path adjusting mechanism (not shown). By the additional optical path adjusting mechanism, the light beams (LB11˜LB15, LB21˜LB25, LB31˜LB35, LB41˜LB45, LB51˜LB55) may be guided to an action region for detecting the physical object F. That is, these light beams are guided to the sensing range for sensing the physical object F. In this situation, before the physical object F enters the action region, the light beams could be recycled and reused in order to achieve the power-saving and cost-effective purposes. In some embodiments, the additional optical path adjusting mechanism comprises plural flat reflective mirror or plural curved reflective mirrors.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A pointing input device, comprising:
a sheet-like light beam layer abutting a display screen and distributed on a surface of a display screen, and including plural light beams, wherein said sheet-like light beam layer is generated by at least one light-generating module having a dot light source; and
a detector for detecting a light spot composed of plural reflective beam when a physical object is intervened into said sheet-like light beam layer, so that a pointing input operation is performed on a specified position of said display screen corresponding to said light spot, wherein once said physical object is intervened into said sheet-like light beam layer, said light beams are sheltered by said physical object, so that said light spot with a reflective bright border is resulted from a touching action of said physical object.

2. The pointing input device according to claim 1 wherein said sheet-like light beam layer is a flat sheet-like light beam layer or a curved sheet-like light beam layer.

3. The pointing input device according to claim 1 wherein said pointing input device comprises a single light-generating module abutting a specified corner of said display screen, or wherein said pointing input device comprises two light-generating modules respectively arranged on a left corner and a right corner of said display screen, or wherein said pointing input device comprises two light-generating modules respectively arranged at one of an upper side and a lower side of said display screen and one of a left side and a right side of said display screen.

4. The pointing input device according to claim 1 wherein said light-generating module comprises:
a light-emitting element abutting said surface of said display screen, and serving as said dot light source for generating a source light beam; and
an optical path adjusting mechanism arranged corresponding to said light-emitting element for reflecting and/or refracting said source light beam, thereby generating said light beams of said sheet-like light beam layer.

5. The pointing input device according to claim 4 wherein said optical path adjusting mechanism comprises plural beam splitters arranged in parallel with each other, so that said source light beam is successively transmitted through and reflected by said beam splitters to generate said light beams, or wherein said optical path adjusting mechanism comprises a polygonal reflective mirror, which is rotated to reflect said source light beam, thereby generating said light beams, or wherein said optical path adjusting mechanism comprises a single-surface reflective mirror, which is rotated to reflect said source light beam, thereby generating said light beams, or wherein said optical path adjusting mechanism comprises a meniscus concave-convex lens.

6. The pointing input device according to claim 5 wherein said optical path adjusting mechanism further comprises an angle-amplifying lens, which is arranged in front of said polygonal reflective mirror or in front of said single-surface reflective mirror for diverging said source light beam, thereby generating said light beams.

7. The pointing input device according to claim 4 wherein said light beams are not interfered with each other, or interfered with each other in a staggered manner.

8. The pointing input device according to claim 4 further comprising an additional optical path adjusting mechanism for guiding said light beams to an action region for detecting said physical object.

9. The pointing input device according to claim 8 wherein said additional optical path adjusting mechanism comprises plural flat reflective mirror or plural curved reflective mirrors.

10. The pointing input device according to claim 1 wherein said detector comprises a single video camera or a linear array arranged in front of or behind said display screen, or wherein said detector comprises two video cameras or two linear arrays abutting said display screen and arranged on left and right corners of said display screen, or wherein said detector comprises two video cameras or two linear arrays abutting said display screen and respectively arranged at one of an upper side and a lower side of said display screen and one of a left side and a right side of said display screen, or wherein said detector comprises three or more than three video cameras or three or more than three linear arrays arranged in a line, or wherein said detector comprises plural optical receivers distributed at said upper side, said lower side, said left side and/or said right side of said display screen.

11. The pointing input device according to claim 1 wherein said physical object includes a finger, multiple fingers or a stick-like article.

12. The pointing input device according to claim 1 wherein said display screen is a computer screen, a television screen, a handheld device screen, a handwriting board screen, a multi-screen video wall or a projection screen.

13. The pointing input device according to claim 1 wherein when said pointing input operation is performed, pointing information associated with mouse left/right button, light spot position, light spot size and/or touching pressure is simultaneously identified and inputted.

14. A pointing input device, comprising:
at least one light-emitting element abutting a surface of said display screen, and serving as said dot light source for generating a source light beam;
an optical path adjusting mechanism arranged corresponding to said light-emitting element for reflecting and/or refracting said source light beam, thereby generating a sheet-like light beam layer having plural light beams; and
a detector for detecting plural reflective beam when a physical object is intervened into said sheet-like light beam layer and said light beams are sheltered by said physical object, so that an intervening position of said physical object is realized and a pointing input operation is performed on a specified position of said display screen corresponding to said intervening position of said physical object.

15. The pointing input device according to claim 14 wherein said sheet-like light beam layer is a flat sheet-like light beam layer or a curved sheet-like light beam layer.

16. The pointing input device according to claim 14 wherein the at least one light-emitting element and said optical path adjusting mechanism collectively define a light-generating module.

17. The pointing input device according to claim 16 wherein said pointing input device comprises a single light-generating module abutting a specified corner of said display screen, or wherein said pointing input device comprises two light-generating modules respectively arranged on a left corner and a right corner of said display screen, or wherein said pointing input device comprises two light-generating modules respectively arranged at one of an upper side and a lower side of said display screen and one of a left side and a right side of said display screen.

18. The pointing input device according to claim 14 wherein said optical path adjusting mechanism comprises plural beam splitters arranged in parallel with each other, so that said source light beam is successively transmitted through and reflected by said beam splitters to generate said light beams, or wherein said optical path adjusting mechanism comprises a polygonal reflective mirror, which is rotated to reflect said source light beam, thereby generating said light beams, or wherein said optical path adjusting mechanism comprises a single-surface reflective mirror, which is rotated to reflect said source light beam, thereby generating said light beams, or wherein said optical path adjusting mechanism comprises a meniscus concave-convex lens.

19. The pointing input device according to claim 18 wherein said optical path adjusting mechanism further comprises an angle-amplifying lens, which is arranged in front of said polygonal reflective mirror or in front of said single-surface reflective mirror for diverging said source light beam, thereby generating said light beams.

20. The pointing input device according to claim 14 wherein said light beams are not interfered with each other, or interfered with each other in a staggered manner.

21. The pointing input device according to claim 14 further comprising an additional optical path adjusting mechanism for guiding said light beams to an action region for detecting said physical object.

22. The pointing input device according to claim 21 wherein said additional optical path adjusting mechanism comprises plural flat reflective mirror or plural curved reflective mirrors.

23. The pointing input device according to claim 14 wherein said detector comprises a single video camera or a linear array arranged in front of or behind said display screen, or wherein said detector comprises two video cameras or two linear arrays abutting said display screen and arranged on left and right corners of said display screen, or wherein said detector comprises two video cameras or two linear arrays abutting said display screen and respectively arranged at one of an upper side and a lower side of said display screen and one of a left side and a right side of said display screen, or wherein said detector comprises three or more than three video cameras or three or more than three linear arrays arranged in a line, or wherein said detector comprises plural optical receivers distributed at said upper side, said lower side, said left side and/or said right side of said display screen.

24. The pointing input device according to claim 14 wherein said physical object includes a finger, multiple fingers or a stick-like article.

25. The pointing input device according to claim 14 wherein said display screen is a computer screen, a television screen, a handheld device screen, a handwriting board screen, a multi-screen video wall or a projection screen.

26. The pointing input device according to claim 14 wherein once said physical object is intervened into said sheet-like light beam layer, said light beams are sheltered by said physical object, so that a light spot with a reflective bright border is resulted from a touching action of said physical object.

27. The pointing input device according to claim 26 wherein when said pointing input operation is performed, pointing information associated with mouse left/right button, light spot position, light spot size and/or touching pressure is simultaneously identified and inputted.
